(19) United States
(12) Patent Application Publication
(10) Pub. No.: US 2013/0060390 A1
(43) Pub. Date: Mar. 7, 2013

(54) ENERGY-SAVING DIAGNOSTIC SYSTEM

(71) Applicants: Tomoya Sogo, Osaka (JP); Hiroki Kazuno, Osaka (JP)

(72) Inventors: Tomoya Sogo, Osaka (JP); Hiroki Kazuno, Osaka (JP)

(73) Assignee: PANASONIC CORPORATION, Osaka (JP)

(21) Appl. No.: 13/698,328

(22) PCT Filed: May 25, 2011
(86) PCT No.: PCT/JP2011/061971

§ 371 Date: Nov. 16, 2012

(30) Foreign Application Priority Data
May 25, 2010 (JP) 2010-119618

(51) Int. Cl. G06F 1/32

(52) U.S. Cl. 700/286

(57) ABSTRACT

Providing an energy-saving diagnostic system with which an energy saving effect brought about by modifying schedule control information can be confirmed easily. A comparison and evaluation unit 28 sets a point in time at which schedule control information is modified by a schedule setting unit 25, as a start point of an evaluation mode. When the evaluation mode starts, the comparison and evaluation unit 28 sets use information obtained over a predetermined period (i.e. in units of days, weeks, months, or years) before the start point of the evaluation mode as reference data, sets use information obtained over the predetermined period after the start point as performance data, and compares the reference data with performance data constituted. The comparison and evaluation unit 28 outputs a comparison data and to cause a user terminal 3 to display the energy saving effect brought about by modifying the schedule control information.

### TECHNICAL FIELD

The present invention relates to an energy-saving diagnostic system that monitors an amount of a resource used by a controlled subject, and more particularly to an energy-saving diagnostic system that monitors a use time of the resource according to respective operations of a plurality of controlled subjects.

### BACKGROUND ART

Various controllers for controlling a plurality of controlled subjects have been proposed in the related art. This type of controller operates the controlled subjects and stops operations of the controlled subjects by outputting a control command to each controlled subject at a predetermined time in accordance with predetermined schedule control information. The controller uses a time-division multiplex transmission method to communicate with the respective controlled subjects, and communicating with the plurality of controlled subjects in sequence, thereby the controller can transmit control commands for operating the controlled subjects and obtain conditions of the controlled subjects.

Further, in recent years, approach for reducing energy resource consumption have been applied more vigorously in units of buildings and facilities. As an example of an approach to reduce energy resource consumption, a period (a use permission period) during which use of electric power, which is a type of resource, is permitted may be set. When a use permission period is set, an energy-saving diagnostic system that monitors an electric power use time of a controlled subject determines whether or not electric power use through an operation of the controlled subject is within the use permission period. And then, the energy-saving diagnostic system displays the electric power use according to whether or not the electric power use is within the use permission period, on the basis of the determination result. Thus, a user can be encouraged to stop using the resource by operating the controlled subject outside the use permission period, and to use the resource within the use permission period.

Further, a controller such as that described above may be employed in this energy-saving diagnostic system. In this configuration, if the resource is used outside the use permission period, the user can modify (change) the schedule control information in accordance with the information displayed by the energy-saving diagnostic system so that the use time is brought within the use permission period. As a result, use of the resource by operating the controlled subject outside the use permission period can be suppressed, enabling a reduction in energy resource consumption. In this instance, if the system can make the user confirm the magnitude of an energy saving effect brought about by modifying the schedule control information when the user modifies the schedule control information using the controller, the user can be further encouraged to save energy.

Meanwhile, a system that enables confirmation of the energy saving effect by: storing data indicating an amount of electric power (an amount of electricity) used by a controlled subject (an electrical device) successively in time series; and displaying results so as to compare the stored data with an amount of used electric power with respect to different periods of identical predetermined period, has been proposed (see Japanese Patent Application Publication No. 2008-202985, for example). In the system described in this Patent Document, after the elapse of a predetermined period following a timing at which a user performs an operation to request the result, an amount of electric power used during a predetermined period before the operation timing and an amount of electric power used during the same predetermined period after the operation timing are compared.

With the configuration of the Patent Document described above, however, although the user can see how the electric power use amount has varied on either side of the timing of the operation requesting the result, the user cannot check variation in the electric power use amount accompanying modification of the schedule control information. In other words, even when the user modifies the schedule control information using the controller, a result displayed in response to a subsequent user operation does not directly express the energy saving effect brought about by modifying the schedule control information.

As a method for confirming the energy saving effect brought about by modifying the schedule control information, the user may: record data indicating the use time of the resource prior to modification of the schedule control information in advance; compare these data with data indicating the use time following modification of the schedule control information; and evaluate a comparison result. With this method, however, the user cannot easily confirm the energy saving effect, and it is therefore difficult to encourage the user to make further efforts to save energy by confirming the effect brought about by modifying the schedule control information.

### DISCLOSURE OF INVENTION

The present invention has been designed in consideration of the circumstances described above, and an object thereof is to provide an energy-saving diagnostic system with which an energy saving effect brought about by modifying schedule control information can be confirmed easily.

As energy-saving diagnostic system according to the present invention, which has an evaluation mode and monitors a use amount of a resource used by a controlled subject, includes: a control unit that outputs a control command to adjust the use amount in accordance with predetermined schedule control information; an information acquisition unit that obtains information for obtaining the use amount used by the controlled subject, periodically as use information; an information storage unit that stores time series data in which the use information is associated with at least a date on which the use information is obtained; a schedule setting unit that sets the schedule control information; a comparison and evaluation unit that compares use amounts on either side of a reference point when the evaluation mode is set; and a display unit, wherein the comparison and evaluation unit: sets a point in time at which the schedule control information is modified by the schedule setting unit as the reference point; sets the use information obtained over a predetermined period before the reference point as reference data; sets the use information obtained over the same predetermined period after the reference point as performance data; and causes the display unit to display an energy saving effect brought about by modifying the schedule control information on the basis of the performance data and the reference data.

In this energy-saving diagnostic system, the use amount of the resource is preferably a use time of the resource, and the energy-saving diagnostic system preferably monitors the use time of the resource during respective operations of a plurality of the controlled subjects. The control unit preferably controls the operations of the plurality of controlled subjects by outputting the control command to the controlled subjects at a predetermined time in accordance with the predetermined schedule control information. The information acquisition unit preferably obtains information relating to a use condition of the resource as the use information. The information storage unit preferably stores the use information in time series in association with the date on which the use information is obtained. The comparison and evaluation unit preferably compares the use times of the resource on either side of a start point of the evaluation mode when the evaluation mode is set. In other words, the reference point is preferably the start point of the evaluation mode. The comparison and evaluation unit preferably: compares the performance data to the reference data; and causes the display unit to display a comparison result, thereby display the energy saving effect brought about by modifying the schedule control information.

In this energy-saving diagnostic system, the comparison and evaluation unit preferably generates the reference data from the use information stored in the information storage unit so as to exclude use information obtained on a special day on which the use amount differs from normal.

In this energy-saving diagnostic system, the information storage unit preferably stores, together with the use information, special day information indicating whether or not a day on which the use information is obtained is the special day.

In this energy-saving diagnostic system, the comparison and evaluation unit preferably generates the reference data from the use information stored in the information storage unit so as to exclude use information from which data have been lost.

In this energy-saving diagnostic system, the comparison and evaluation unit preferably: calculates a ratio that expresses, as a numerical value, a ratio between the use amount defined in relation to the performance data and the use amount defined in relation to the reference data; and causes the display unit to display the ratio together with an increase/decrease display indicating whether the use amount has increased or decreased on either side of the reference point.

In this energy-saving diagnostic system, the comparison and evaluation unit preferably causes, when the reference data include the use information obtained on a special day on which the use amount differs from normal or the use information from which data have been lost, the display unit to display a warning display, which indicates including an abnormal value, within at least one of the ratio and the increase/decrease display.

In this energy-saving diagnostic system, the comparison and evaluation unit preferably rounds up a value of a least significant digit during the calculation of the ratio, and causes the display unit to display a result as the ratio.

In this energy-saving diagnostic system, the schedule setting unit preferably starts the evaluation mode automatically when the schedule control information is modified in order to reduce the use amount.

In this energy-saving diagnostic system, the comparison and evaluation unit preferably sets, as the reference data, use information obtained in an identical season to a season in which the performance data are obtained.

In this energy-saving diagnostic system, the comparison and evaluation unit preferably has a first threshold and a second threshold that is smaller than the first threshold, and causes the display unit to display different increase/decrease displays according to whether the ratio is larger than the first threshold, within a range of the first threshold and the second threshold, or smaller than the second threshold.

This energy-saving diagnostic system preferably further includes a setting holding area for storing at least a start day of the evaluation mode.

In this energy-saving diagnostic system, the setting holding area preferably also stores a duration of the evaluation mode.

The present invention is advantaged in that an energy saving effect brought about by modifying schedule control information can be confirmed easily.

### BRIEF DESCRIPTION OF DRAWINGS

FIG. 1 shows an energy-saving diagnostic system according to a first embodiment, wherein FIG. 1A is a schematic view showing an overall configuration, and FIG. 1B is a schematic block diagram showing a configuration of a controller;

FIG. 2 is a view showing a display screen of a user terminal according to the first embodiment;

FIG. 3 is a view showing another display screen of the user terminal according to the first embodiment;

FIG. 4 is a view showing a yet another display screen of the user terminal according to the first embodiment;

FIG. 5 is a view showing a calendar used to illustrate the first embodiment;

FIG. 6 is a view showing a calendar used to illustrate the first embodiment;

FIG. 7 is a view showing a calendar used to illustrate the first embodiment;

FIG. 8 is a sequence diagram showing a behavior according to the first embodiment; and

FIG. 9 is a sequence diagram showing a behavior of the controller according to the first embodiment.

### DESCRIPTION OF EMBODIMENTS

The present invention is a system that monitors an amount of a resource used by a controlled subject. In particular, an energy-saving diagnostic system according to this embodiment is a system that monitors a use time of the resource during respective operations of a plurality of controlled subjects. It will be described below about such a case in which the energy-saving diagnostic system is used in a store such as a supermarket and the resource is electric power, as an example.

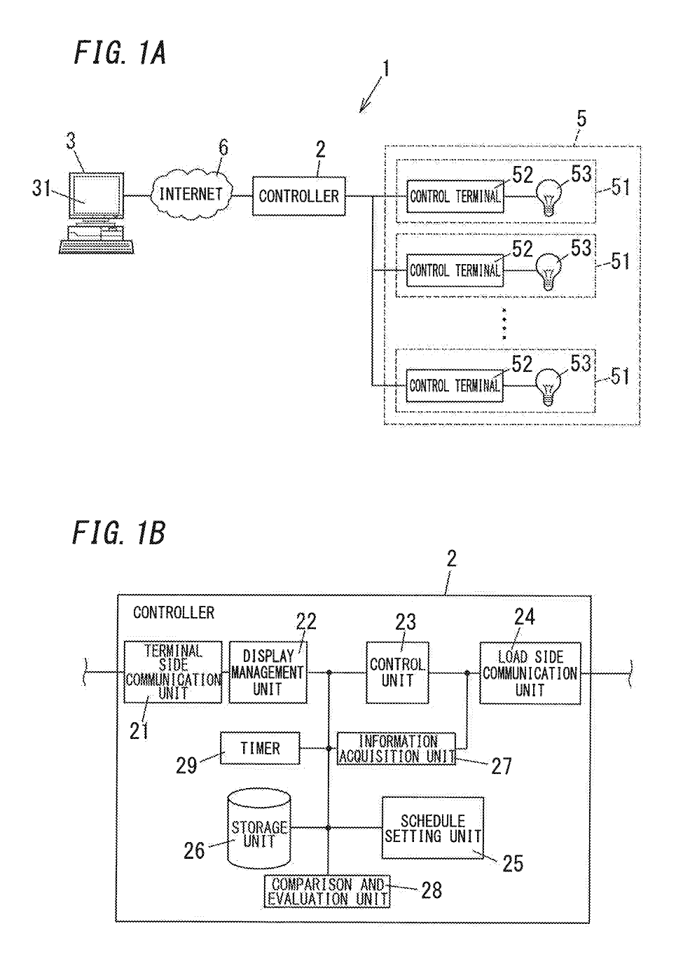

As shown in FIG. 1A, an energy-saving diagnostic system 1 includes a controller 2 and a user terminal 3. A facility system 5 is connected to the energy-saving diagnostic system 1.

The facility system 5 is constituted by a plurality of controlled subjects 51. Each controlled subject 51 is a combination of a control terminal 52 having a relay, and a lighting load (e.g. a lamp) 53. The lighting load 53 is illuminated and extinguished according to ON and OFF of the relay of the control terminal 52. Note that here, the lighting load 53 is used as the controlled subject 51 of the facility system 5, but a load other than the lighting load 53, for example an air-conditioning facility or the like, may be used as the controlled subject instead.

The user terminal 3 is a computer such as a personal computer managed by a store manager, for example, and includes a display screen 31. The user terminal 3 displays (as will be described in detail below) illumination conditions of the respective lighting loads 53, which are gathered by the controller 2, on the display screen 31 using such as a Web browser or the like.

As shown in FIG. 1B, the controller 2 includes a terminal side communication unit 21, a display management unit 22, a control unit 23, a load side communication unit 24, a schedule setting unit 25, a storage unit 26, an information acquisition unit 27, a comparison and evaluation unit 28, and a timer 29. The controller 2 communicates with the control terminals 52 of the respective controlled subjects 51 using a time-division multiplex transmission method. Note that it may employ another system configuration in which a local control controller (not shown) is connected to the controller 2 and the plurality of control terminals 52 such that the local control controller manages the exchange of data between the controller 2 and the control terminals 52 in a concentrated fashion.

The control unit 23 controls illumination of the lighting loads 53 by ON/OFF controlling the relays of control terminals 52 according to a preset schedule control information. The schedule control information is set in advance in a setting holding area of the storage unit 26. In this instance, the setting holding area serves as a schedule storage unit. The schedule control information includes a set of (a group of) information in which a specific time, a controlled subject, and control content (switching the relay ON or OFF) are associated with each other. The schedule control information is set by the schedule setting unit 25, as will be described below.

More specifically, with referring to the schedule control information in the storage unit 26, when a current time measured by the timer 29 reaches the specific time, the control unit 23 generates a control command for switching the relay of the subject control terminal 52 ON or OFF in accordance with the control content. The control command herein is a command for causing the controlled subject 51 to execute an operation to start or stop using electric power. In other words, the control command is a command for adjusting an amount of electric power used by the controlled subject 51. Having generated the control command, the control unit 23 transmits the control command to an intended control terminal 52 using the load side communication unit 24. As a result, an operation of the controlled subject 51 is controlled in accordance with the schedule control information.

The information acquisition unit 27 obtains the ON/OFF conditions of the respective relays periodically from the respective control terminals 52 by communicating periodically with the respective control terminals 52 using the load side communication unit 24. In other words, the information acquisition unit 27 constantly monitors the ON/OFF conditions of the respective relays by periodically obtaining information indicating the ON/OFF conditions of the respective control terminals 52.

The ON/OFF condition of the relay of the control terminal 52 is linked to the illumination condition of the lighting load 53, and therefore, the information acquisition unit 27 monitors the illumination conditions of the respective lighting loads 53 by means of monitoring the ON/OFF conditions of the respective relays. Thus, the information acquisition unit 27 can periodically obtain information relating to an electric power use condition by an operation of each controlled subject 51 (in other words, information from which the amount of power used by each controlled subject 51 can be obtained) as use information, and thereby monitor the electric power use time of each controlled subject 51 (in other words, the amount of electric power used by each controlled subject 51).

The obtained use information is stored in a data holding area of the storage unit 26 in time series for each controlled subject 51 in association with information indicating an acquisition date and time (or date). In this instance, the data holding area serves as an information storage unit.

Further, the information acquisition unit 27 outputs information indicating the ON/OFF conditions of the respective relays, or in other words the illumination conditions of the respective lighting loads 53, which is gathered from the respective control terminals 52, to the display management unit 22.

The display management unit 22, following input of the information indicating the ON/OFF conditions of the relays of the respective control terminals 52 from the control unit 23, generates data for causing the user terminal 3 to display the information indicating the ON/OFF conditions of the respective relays. The display management unit 22 then transmits the generated data to the user terminal 3 using the terminal side communication unit 21.

The terminal side communication unit 21 is connected to an Internet 6 serving as an external network using Ethernet (registered trademark) to be capable of communicating with the user terminal 3, which is similarly connected to the Internet 6. Accordingly, the display management unit 22 displays the generated data on the display screen 31 of the user terminal 3 upon reception of a request transmitted from the user terminal 3 via the Internet 6. Needless to mention, the terminal side communication unit 21 may be connected to the user terminal 3 directly.

Here, the display management unit 22 is capable of setting a period during which electric power use is permitted in advance as a use permission period, and is capable of causing the user terminal 3 to display the electric power use corresponding to the obtained use information according to whether or not the electric power use is within the use permission period. The use permission period is set in advance for each controlled subject 51 and stored in the setting holding area of the storage unit 26.

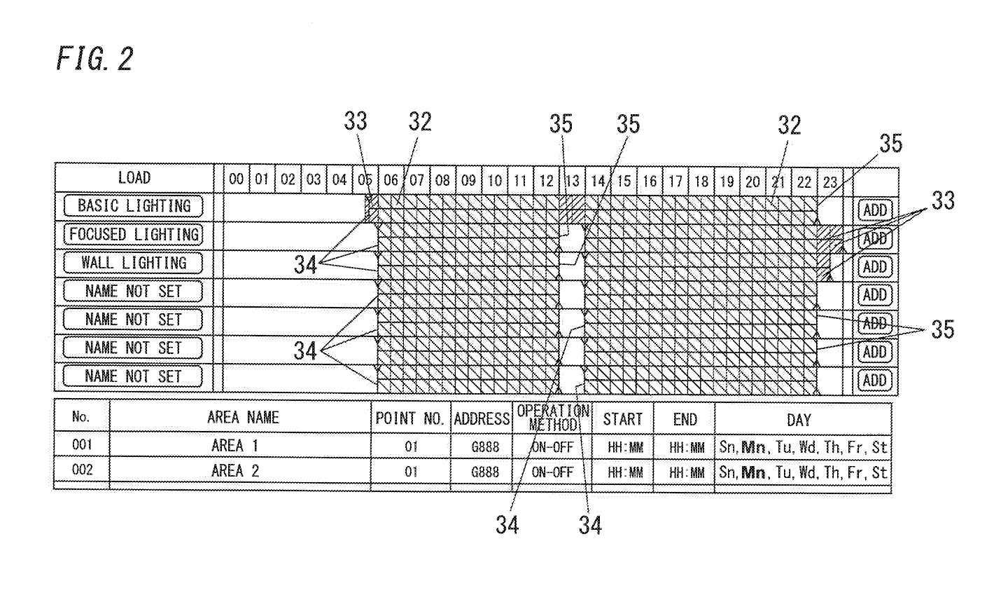

In other words, as shown in FIG. 2, the user terminal 3 uses the use information obtained by the information acquisition unit 27 to display the electric power use time according to whether or not the electric power use time is within the use permission period. Note that in FIG. 2, a code 32 denotes use within the use permission period and a code 33 denotes use outside the use permission period.

The user terminal 3 displays the electric power use condition in predetermined period units (of ten minutes, for example). In a case where the predetermined period is ten minutes, for example, even when electric power is used only for a small amount (one minute, for example) of the ten-minute predetermined period, the display on the user terminal 3 indicates that electric power was used over the entire subject predetermined period. In other words, an identical display is displayed on the user terminal 3 in the location of the subject predetermined period regardless of whether electric power was used only for a short time or electric power was used continuously for ten minutes.

The schedule setting unit 25 has a function for setting the schedule control information, which is used by the control unit 23 to control the controlled subjects 51. In this embodiment, the schedule setting unit 25 is configured to reflect schedule control information set on the display screen 31 (as shown in FIG. 2) of the user terminal 3 into the storage unit 26.

More specifically, in FIG. 2, the schedule control information is set in accordance with an ON control point 34 representing a specific time at which a controlled subject 51 is switched ON and an OFF control point 35 representing a specific time at which the controlled subject 51 is switched OFF, for each controlled object 51. Hence, the control unit 23 controls controlled subject 51 to an ON condition (an illuminated condition) during a period between the ON control point 34 and the OFF control point 35.

The ON control point 34 and the OFF control point 35 can be slid along a time axis direction over the display screen 31 of the user terminal 3 using a mouse or the like, and the schedule control information is adjusted by adjusting the positions of these control points. When a register button (not shown) on the display screen 31 is pressed, the schedule setting unit 25 updates the schedule control information in the storage unit 26 in accordance with the positions of the ON control points 34 and the OFF control points 35 at that time.

Hence, by providing the schedule setting unit 25, a user can modify the schedule control information easily on the user terminal 3 while checking whether or not the electric power use is within the use permission period. Note that a method of modifying the schedule control information is not limited to the method described above. For example, such a method may be used in which respective schedule control start and end times are input into a table displayed in a lower section of FIG. 2 using a keyboard.

The energy-saving diagnostic system 1 has an evaluation mode. When the evaluation mode is set, the comparison and evaluation unit 28 compares the electric power use times before and after a start point of the evaluation mode. A comparison result obtained by the comparison and evaluation unit 28 is output to the display management unit 22, transmitted therefrom to the user terminal 3 using the terminal side communication unit 21, and displayed on the display screen 31. In other words, the user terminal 3 functions as a display unit for displaying the comparison result obtained by the comparison and evaluation unit 28.

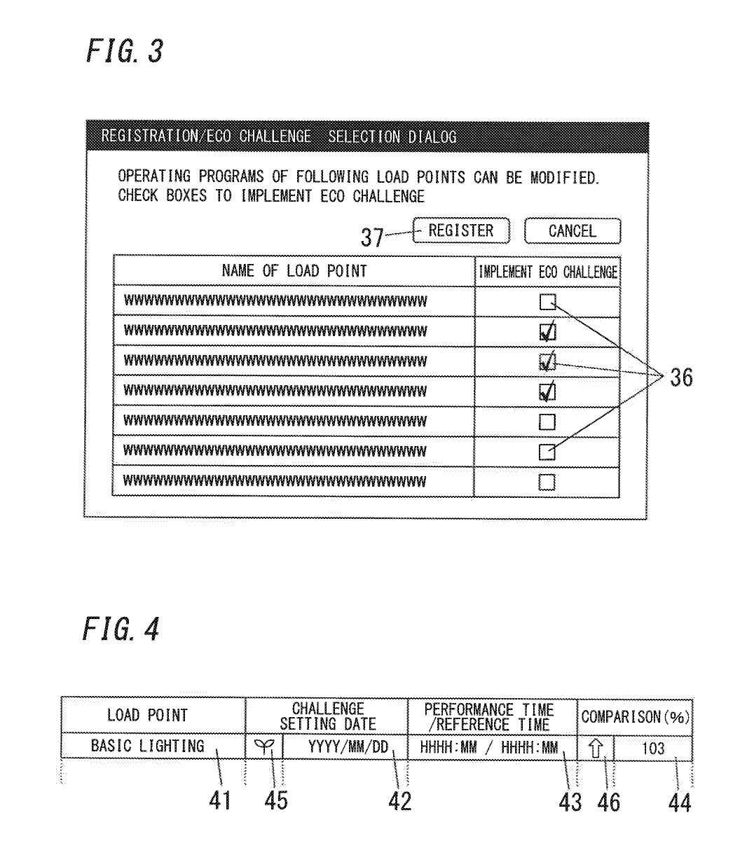

In the energy-saving diagnostic system 1 according to this embodiment, the comparison and evaluation unit 28 sets a point in time at which the schedule control information is modified by the schedule setting unit 25 as a start point of the evaluation mode (a reference point). More specifically, when the schedule control information is modified by adjusting the positions of the ON control points 34 and the OFF control points 35 on the display screen 31 and pressing the register button, the display management unit 22 displays a dialog such as that shown in FIG. 3 on the display screen 31.

The dialog shown in FIG. 3 is a screen for confirming whether or not to implement the evaluation mode (also referred to as an “eco challenge” hereafter). The dialog includes check boxes 36 for confirming whether or not to implement the evaluation mode in relation to each controlled subject (name of load point) 51. When, at this time, a register button 37 is pressed in a condition where a check has been input into at least one of the check boxes 36, the comparison and evaluation unit 28 starts the evaluation mode (the eco challenge) in relation to the checked controlled subject 51. The start date and time of the evaluation mode is stored in the setting holding area of the storage unit 26.

When the evaluation mode starts, the comparison and evaluation unit 28 defines “use information obtained over a predetermined period (units of days, weeks, months, or years, for example) before the start point of the evaluation mode” as reference data, defines “use information obtained over the same predetermined period after the start point” as performance data, and compares the performance data with the reference data. In other words, in the evaluation mode according to this embodiment, “use information obtained over the predetermined period before the point at which the schedule control information was modified (i.e. the reference point)” is set as the reference data, “use information obtained over the same predetermined period after the point at which the schedule control information was modified” is set as the performance data, and the performance data is compared with the reference data. Here, the comparison and evaluation unit 28 reads out the use information (where the use information is stored in time series) obtained over a period serving as the reference data and the use information obtained over a period serving as the performance data from the data holding area of the storage unit 26, and sets the read use information as the reference data and the performance data, respectively.

For example, when the predetermined period for the reference data in the evaluation mode is set at one week, the comparison and evaluation unit 28 sets use information obtained over a single week extending from one week prior to the start day of the evaluation mode to the day before the start day of the evaluation mode (in other words, a predetermined period that is identical in length to the predetermined period for obtaining the reference data) as the reference data. In this case, the comparison and evaluation unit 28 sets use information obtained over a single week starting at a day after the start day of the evaluation mode as the performance data, compares the performance data to the reference data, and displays the comparison result on the user terminal 3. In other words, the comparison and evaluation unit 28 causes the user terminal 3 to display an energy saving effect brought about by modifying the schedule control information on the basis of the performance data and the evaluation data.

Accordingly, the user terminal 3 displays, for example, a load point 41 representing the controlled subject 51, a challenge setting day 42 representing the start day of the evaluation mode, a comparison result (comparison data) 43, and a ratio 44 for each controlled subject 51 in the form of a table, as shown in FIG. 4. Note that in FIG. 4, the comparison result 43 and so on are displayed in relation to only one controlled subject 51, but in actuality, the comparison result 43 and so on are displayed similarly for each of the plurality of controlled subjects 51.

The comparison result 43 is displayed in the form of “performance time/reference time”, where the electric power use time corresponding to the reference data is set as the reference time and the electric power use time corresponding to the performance data is set as the performance time. The ratio 44 expresses, as a numerical value, a ratio between the electric power use time represented by the performance data and the electric power use time represented by the reference data. Further, a challenge mark 45 indicating whether or not the evaluation mode has been implemented is displayed beside the challenge setting day 42, and an increase/decrease display 46 indicating whether the electric power use time has increased or decreased is displayed beside the ratio 44.

The ratio 44 is calculated by dividing the performance time by the reference time, and expressed here as a percentage (%). In other words, when the performance time decreases relative to the reference time, the ratio 44 takes a smaller value than 100(%), whereas when the performance time increases relative to the reference time, the ratio 44 takes a larger value than 100(%).

Here, when calculating the ratio 44, the comparison and evaluation unit 28 rounds up a value of a least significant digit (in the case of FIG. 4, a first decimal place). Hence, when the performance time is shorter than the reference time, for example when performance time/reference time=97.5(%), the displayed ratio 44 becomes 98(%). The user is thus prevented from thinking that an overly large energy reduction has been achieved. On the other hand, when the performance time is longer than the reference time, for example when performance time/reference time=103.4(%), the displayed ratio 44 becomes 104(%). The user is thus prevented from thinking that the increase in the electric power use time is small. Hence, in comparison with a case where the value of the least significant digit obtained during calculation of the ratio 44 is rounded down or rounded off, the user is prevented from thinking that the energy saving effect is overly large or that the increase in the electric power use time is small. Note that the digit (least significant digit) that is rounded up when calculating the ratio 44 is not limited to the first decimal place, and the value of the least significant digit may be rounded up using a second decimal place or a third decimal place as the least significant digit during calculation of the ratio 44.

The increase/decrease display 46 expresses the increase or decrease in the electric power use time following the start point of the evaluation mode by varying an orientation of an arrow. Here, thresholds for determining the orientation of the increase/decrease display 46 are set in relation to the ratio 44. For example, the thresholds are set at ±3(%) of 100(%). In this case, the increase/decrease display 46 takes the form of an upwardly oriented arrow indicating an increase in the electric power use time when the ratio 44 is greater than 103(%) (a first threshold), and takes the form of a downwardly oriented arrow indicating a reduction in the electric power use time when the ratio 44 is smaller than 97(%) (a second threshold). When the ratio 44 is within a range of 100±3(%), the increase/decrease display 46 takes the form of a laterally oriented (rightward) arrow. In other words, the comparison and evaluation unit 28 includes a first threshold and a second threshold that is smaller than the first threshold, and different increase/decrease displays 46 are displayed by the display unit 31 according to whether the ratio 44 is larger than the first threshold, within the range of the first threshold and the second threshold, or smaller than the second threshold. Note that the controller 2 may be configured to be capable of setting the thresholds for determining the orientation of the increase/decrease display 46 as desired in response to operation input from the user terminal 3.

Hence, by checking the display on the display screen 31 of the user terminal 3, such as that shown in FIG. 4, the user can check how the electric power use time has varied on either side of the start point of the evaluation mode (between before and after the start point). Here, the start point of the evaluation mode is the point in time at which the schedule control information was modified, and therefore the user can confirm the energy saving effect brought about by modifying the schedule control information. Moreover, the ratio 44 expresses the energy saving effect quantitatively, while the increase/decrease display 46 expresses the energy saving effect qualitatively, and therefore the user can grasp the energy saving effect easily.

FIG. 4 shows an example in which the performance data and the reference data are compared in relation to each controlled subject 51 and the comparison results are displayed for each controlled subject 51. In another configuration, however, some of controlled subjects 51 are grouped, the performance data and the reference data are compared in relation to each group, and the comparison results are displayed for each group. The groups are set in advance such that a plurality of controlled subjects 51 disposed in an identical area, for example, form one group, and the respective groups are specified by group names (“shop floor area” or the like, for example) attached thereto. Needless to mention, arbitrary groups including desired controlled subjects 51 may be set (formed) in response to operation input from the user terminal 3.

Note that when the evaluation mode is set a plurality of times in relation to the same controlled subject 51, the comparison and evaluation unit 28 compares the electric power use times on either side of the start point of the latest evaluation mode.

Next, a relationship between the reference data and the performance data compared by the comparison and evaluation unit 28 will be described in detail.

Typically (Conventionally), when comparing electric power use times obtained over a single week, “the electric power use time obtained over a week extending from one week prior to a day on which the comparison result is viewed to a day before the viewing day” is set as the performance data, “the electric power use time over a previous week thereto” is set as the reference data, and the two electric power use times are compared.

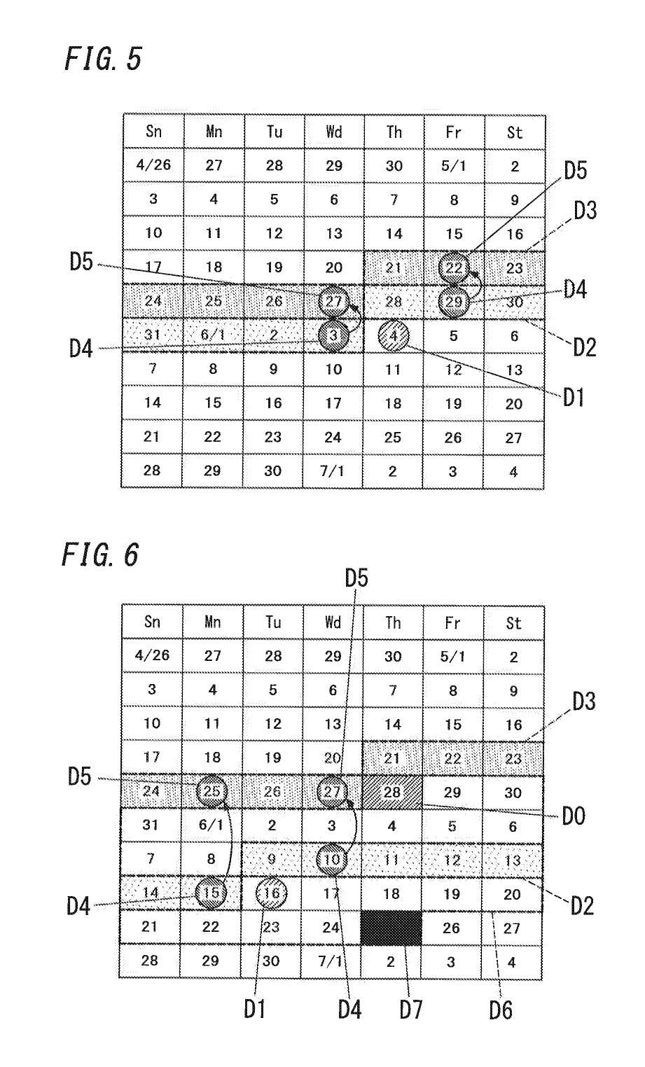

More specifically, as shown in FIG. 5, if a comparison result viewing day D1 is June 4 and therefore a week extending from May 28 to June 3 serves as a performance data acquisition period D2, a previous week thereto, i.e. a week extending from May 21 to May 27, serves as a reference data acquisition period D3. Likewise, in a case where comparing electric power use times obtained over a single day, if a performance data acquisition period D4 is set at June 3, a reference data acquisition period D5 will be one week previous thereto, i.e. May 27, and if the performance data acquisition period D4 is set at May 29, the reference data acquisition period D5 will be May 22.

In contrast, in this embodiment, in a case where electric power use times obtained over a single week are compared, the comparison and evaluation unit 28 sets the electric power use time obtained over a single week extending from one week prior to the start day of the evaluation mode to a day before the start day of the evaluation mode as the reference data, regardless of the day on which the comparison result (see FIG. 4) is viewed.

More specifically, as shown in FIG. 6, if an evaluation mode start day D0 is May 28, the week previous to the start day D0, i.e. a week extending from May 21 to May 27, is set as the reference data acquisition period D3 irrespective of a comparison result viewing day D1. And then, if the comparison result viewing day D1 is June 16 (i.e. the comparison result is viewed at June 16), the week previous thereto, i.e. June 9 to June 15, is set as the performance data acquisition period D2. Likewise, in a case where comparing electric power use times obtained over a single day, if the performance data acquisition period D4 is set at June 10, the reference data acquisition period D5 will be the same day of the week as June 10 before the evaluation mode start day (May 28) D0, i.e. May 27, and if the performance data acquisition period D4 is set at June 15, the reference data acquisition period D5 will be the same day of the week as June 15 before the evaluation mode start day (May 28) D0, i.e. May 25.

Note that a length of an evaluation mode duration D6 is set in advance, and in the example of FIG. 6, June 25, which is four weeks after the evaluation mode start day D0, is set as an evaluation mode end day D7. The comparison and evaluation unit 28 is capable of setting an arbitrary period within the evaluation mode duration D6 as the performance data acquisition period. The length of the evaluation mode duration D6 is stored in the setting holding area of the storage unit 26, for example. In this embodiment, the length of the evaluation mode duration D6 is set in advance, and therefore a situation in which the reference data acquisition period and the performance data acquisition period are too far removed from each other can be avoided. In other words, a situation in which the user does not modify the schedule control information for a long time such that the reference data acquisition period differs greatly from the performance data acquisition period, for example, can be avoided. Note that when the evaluation mode end day D7 arrives, the comparison and evaluation unit 28 may display a dialog on the display screen 31 (not shown) for notifying the user that the end day has arrived.

The length of the evaluation mode duration D6 is set to be shorter than a number of days' worth of use information that can be stored in the data holding area of the storage unit 26. In this instance, a configuration in which the user sets the length of the evaluation mode duration D6 through the user terminal 3 may be employed.

The comparison and evaluation unit 28 may be configured: to operate according to rules such as those shown in FIG. 6 when the evaluation mode is set; and to operate in a normal mode, in which the reference data and performance data are generated according to typical rules such as those shown in FIG. 5, when the evaluation mode is not set. In this case, the user can choose to operate the comparison and evaluation unit 28 in either the evaluation mode or the normal mode by adding and removing checks to and from the check boxes 36 of the dialog shown in FIG. 3 when modifying the schedule control information.

Incidentally, if the use information serving as the reference data includes use information obtained on a special day (such as a store holiday, a day on which opening hours differ from normal opening hours, or the like) or use information from which data have been lost, a reliability of the reference data decreases. Data loss may occur due to a communication error between the controller 2 and the control terminal 52 or a system stoppage caused by a power cut or the like, for example. In other words, an electric power use time of a special day or a day on which data were lost differs greatly from a normal electric power use time, and therefore the reference data are preferably generated so as to exclude use information obtained on a special day or during a period in which data were lost.

Hence, in this embodiment, the comparison and evaluation unit 28 generates the reference data from the use information stored in the storage unit 26 so as to exclude use information obtained on a special day and use information from which data have been lost. More specifically, if an intended date for obtaining the use information of the reference data (to be referred to hereafter as a “default day”) is a special day or a day on which data were lost, the comparison and evaluation unit 28 obtains the reference data from a day one week before the default day. If the day one week before the default day is also a special day or a day on which data were lost, the comparison and evaluation unit 28 further moves back in one week, and obtains the reference data from a day two weeks before the default day.

By performing a similar operation repeatedly up to a predetermined upper limit number of times, the comparison and evaluation unit 28 generates reference data excluding use information obtained on special days and days on which data were lost. Note that the upper limit number of repeated operations is determined based on the number of days' worth of use information that can be stored in the data holding area of the storage unit 26.

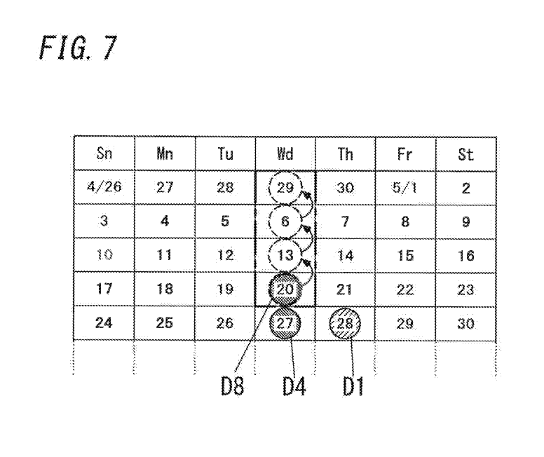

As shown in FIG. 7, for example, if the comparison result viewing day D1 is May 28, the previous day thereto, i.e. May 27, is the performance data acquisition period D4, and the evaluation mode start day (not shown in FIG. 7) is between May 21 and May 26, a day one week before May 27, i.e. May 20, serves as a default day D8. And then, if the default day D8 is a special day or a day on which data were lost, the comparison and evaluation unit 28 sets the reference data using the use information obtained on a day one week before the default day D8, i.e. May 13. If May 13 is also a special day or a day on which data were lost, the comparison and evaluation unit 28 obtains the reference data by moving back successively in one week units to May 6 and April 29.

If all of the days to which the comparison and evaluation unit 28 moves back from the default day are special days up to the upper limit number of operations, however, the comparison and evaluation unit 28 sets the use information of the default day as the reference data, and sets a special day flag indicating that the reference data are constituted by information obtained on a special day. Further, when all of the days to which the comparison and evaluation unit 28 moves back from the default day are days on which data were lost up to the upper limit number of operations, the comparison and evaluation unit 28 determines that a subject day does not exist, and sets an error flag without generating the reference data. Moreover, when all of the days to which the comparison and evaluation unit 28 moves back from the default day are special days or days on which data were lost up to the upper limit number of operations, the comparison and evaluation unit 28 sets the use information obtained on the special day least moved from the default day as the reference data, and sets the special day flag indicating that the reference data are constituted by information obtained on a special day.

When the special day flag or the error flag is set, the comparison and evaluation unit 28 causes the user terminal 3 to display a warning display, which informs a state of including an abnormal value, within (together with) at least one of the ratio 44 and the increase/decrease display 46. More specifically, the comparison and evaluation unit 28 displays the warning display by displaying the ratio 44 and the increase/decrease display 46 in a different color to normal, or displaying a “-” mark. In so doing, a situation in which the user uses data exhibiting low reliability as is and thereby misinterprets the energy saving effect brought about by modifying the schedule control information can be avoided.

Note that the comparison and evaluation unit 28 is not limited to a configuration whereby the reference data are generated so as to exclude both use information obtained on special days and use information from which data have been lost, and may be configured to generate the reference data so as to exclude either use information obtained on special days or use information from which data have been lost.

Further, in this embodiment, special day information indicating whether or not the day on which the information acquisition unit 27 obtained the use information was a special day is stored together with the use information in the data holding area of the storage unit 26. In so doing, the comparison and evaluation unit 28 can determine from the special day information stored in the storage unit 26 whether or not the use information acquisition day was a special day, and as a result, processing for generating the reference data so as to exclude use information obtained on special days is simplified.

Here, calendar information in which special days are associated with dates and days of the week is stored in advance in the setting holding area of the storage unit 26. The comparison and evaluation unit 28 can therefore determine whether or not the date corresponding to the use information was a special day using the calendar information. By determining whether or not the date corresponding to the use information was a special day using the special day information stored in the storage unit 26, the comparison and evaluation unit 28 can determine whether or not the date corresponding to the use information was a special day correctly even when the calendar information is modified. For example, if the store holiday was previously the tenth of each month but is modified to the twentieth of each month, the comparison and evaluation unit 28 can determine a special day correctly from the corresponding special day information even in relation to use information obtained on the tenth prior to modification of the holiday.

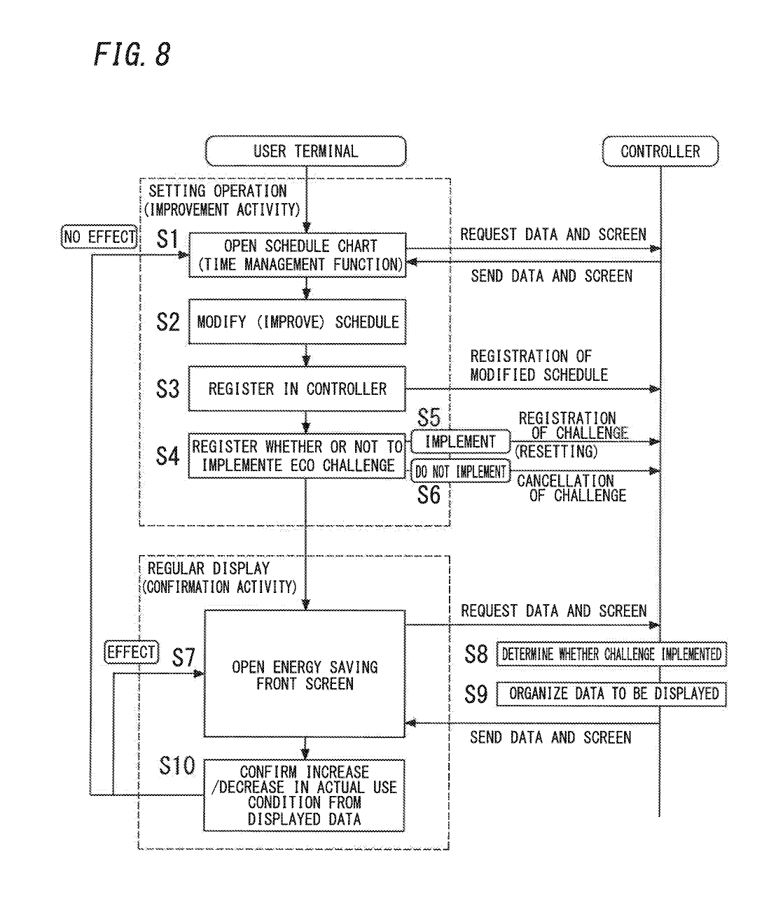

Next, an operation of the energy-saving diagnostic system 1 according to this embodiment will be described with reference to FIG. 8.

First, the user terminal 3 receives operation input from the user, and in accordance therewith displays a schedule chart (see FIG. 2) including the ON control points 34 and the OFF control points 35 of the schedule control information on the display screen 31 (S1). At this time, the user terminal 3 requests data for displaying such a chart from the controller 2, and receives a response from the controller 2.

While the schedule chart is displayed, the user terminal 3 receives operation input from the user, and in accordance therewith modifies (improves) the schedule control information (S2) and registers the modification by transmitting the content of the modification in the controller 2 (S3). At this time, the user terminal 3 displays a dialog (see FIG. 3) to cause the user to choose whether or not to implement the eco challenge (the evaluation mode), and transmits a result to the controller 2 (S4).

When the user chooses to implement the eco challenge (S5), a registration setting command for starting the eco challenge is transmitted from the user terminal 3 to the controller 2. When the user chooses not to implement the eco challenge (S6), a cancellation setting command for terminating the eco challenge is transmitted from the user terminal 3 to the controller 2.

Then, the user terminal 3 receives operation input from the user, and in accordance therewith displays an energy saving front screen showing the comparison results obtained by the comparison and evaluation unit 28 in the eco challenge, such as that shown in FIG. 4, on the display screen 31 (S7). At this time, the user terminal 3 requests data for displaying such a screen from the controller 2, and receives a response from the controller 2. The controller 2 receives the data request from the user terminal 3, determines whether or not the eco challenge has been implemented in relation to each controlled subject 51 (S8), and organizes the data to be displayed on the user terminal 3 (S9).

Thus, by checking the comparison results obtained by the comparison and evaluation unit 28 in the eco challenge on the display screen 31 of the user terminal 3, the user can confirm the energy saving effect brought about by modifying the schedule control information (S10). Note that when an energy saving effect is obtained, the schedule control information may be used as is, but when an energy saving effect is not obtained, the schedule control information is preferably modified further by returning to the processing of S1.

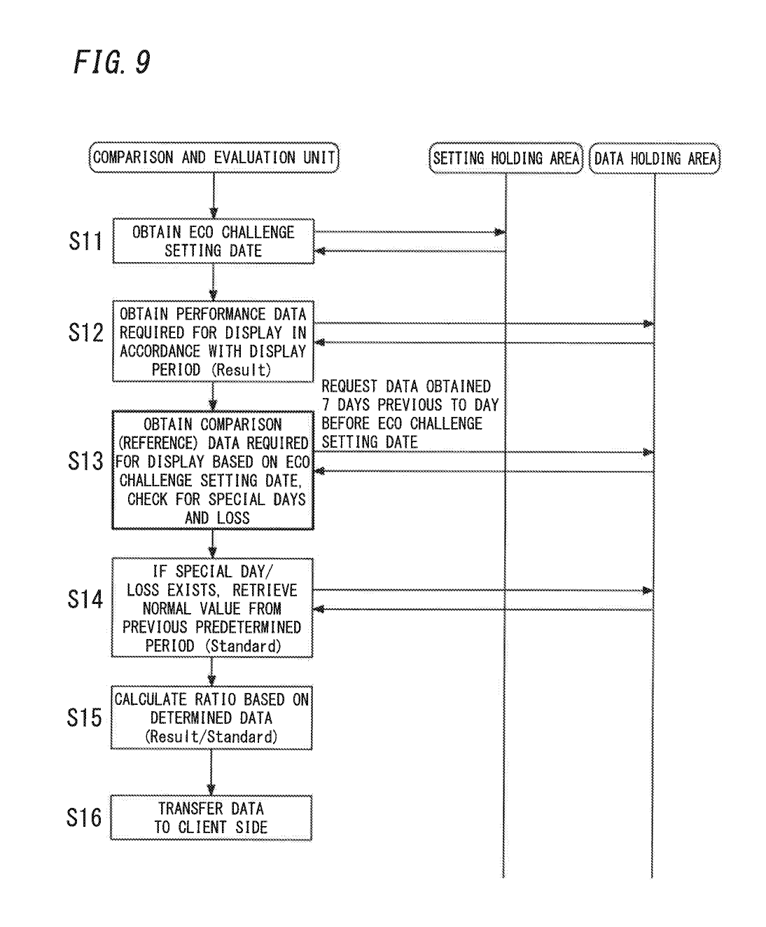

Next, the processing of S8 and S9, performed by the controller 2 upon reception of the data request from the user terminal 3, will be described in detail with reference to FIG. 9.

First, the comparison and evaluation unit 28 reads out the start date of the eco challenge from the setting holding area of the storage unit 26 (S11) and reads out the use information to be used as the performance data from the data holding area of the storage unit 26 (S12). Further, the comparison and evaluation unit 28 reads out the use information to be used as the reference data from the data holding area of the storage unit 26 on the basis of the start day of the eco challenge (S13). At this time, the comparison and evaluation unit 28 checks whether or not the use information to be used as the reference data includes use information obtained on a special day or use information from which data have been lost, and if such use information is included, obtains the reference data from the previous predetermined period (S14).

After obtaining the performance data (Result) and the reference data (Standard), the comparison and evaluation unit 28 calculates the ratio (performance data/reference data) between the two (S15), and transmits the calculation result to the user terminal 3 (S16).

In the energy-saving diagnostic system 1 according to this embodiment having the configuration described above, the comparison and evaluation unit 28 sets a point in time at which the schedule control information is modified as an evaluation mode start point (a reference point), and compares the electric power use times on either side of the schedule control information modification point serving as the evaluation mode start point. In other words, the comparison and evaluation unit 28 uses use information obtained over a predetermined period prior to the schedule control information modification point as the reference data regardless of the comparison result viewing day. Hence, by checking how the electric power use time has varied on either side of the evaluation mode start point on the display screen 31 of the user terminal 3, the user can easily confirm the energy saving effect brought about by modifying the schedule control information.

Further, the comparison and evaluation unit 28 generates the reference data from the use information stored in the storage unit 26 so as to exclude use information obtained on special days and use information from which data have been lost, and therefore use information that differs greatly from a normal electric power use time is not reflected in the reference data. As a result, the reliability of the reference data increases, leading to an improvement in the reliability of the comparison result obtained by the comparison and evaluation unit 28.

Incidentally, an example in which the evaluation mode is started when the register button 37 is pressed in a condition where a check has been added to the check box 36 on the dialog shown in FIG. 3 was described in this embodiment, but the energy-saving diagnostic system 1 may be configured to start the evaluation mode automatically. More specifically, when the schedule control information is modified in order to reduce the electric power use time, the schedule setting unit 25 starts the evaluation mode automatically in relation to the controlled subject 51 for which the schedule control information has been modified, without displaying a dialog such as that shown in FIG. 3. In this instance, the case in which the schedule control information is modified in order to reduce the electric power use time includes such cases in which, for example: the ON control point 34 is retarded; the OFF control point 35 is advanced; an OFF period of the controlled subject 51 is increased; and so on.

By starting the evaluation mode automatically in this manner, the user can be caused to acknowledge the energy saving effect brought about by modifying the schedule control information unconsciously when the schedule control information is modified in order to reduce the electric power use time.

Further, the comparison and evaluation unit 28 may be configured to obtain the reference data from a period belonging to the same season as the date on which the performance data are obtained. In so doing, the energy saving effect brought about by modifying the schedule control information can be accurately determined by the comparison and evaluation unit 28 in relation to a load that varies in operation time according to the season, such as an outdoor lighting load, for example.

A configuration in which the control terminal 52 ON/OFF controls the lighting load 53 was described in the above embodiment, but the present invention may also be applied to a configuration in which the control terminal 52 adjusts a light amount of the lighting load 53. In this case, the schedule control information includes information relating to the light amount emitted by the lighting load 53 in an ON condition in addition to the information relating to the ON control point 34 and the OFF control point 35. Further, the schedule setting unit 25 has a function for setting the light amount emitted by the lighting load 53 in the ON condition. The control unit 23 generates a control command which including the information relating to the light amount of the lighting load 53 in accordance with the schedule control information set by the schedule setting unit 25. Meanwhile, the control terminal 52, for example, includes a measurement unit that measures the amount of electric power used by the lighting load 53. The information acquisition unit 27 periodically obtains the amount of used electric power, measured by the measurement unit of the control terminal 52, as the use information. The obtained use information is stored as time series data in the data holding area serving as the information storage unit of the storage unit 26. The comparison and evaluation unit 28 compares the reference data and the performance data on the basis of the use information, and displays the comparison result on the display screen 31 of the user terminal 3. In this case, the comparison and evaluation unit 28 is configured to compare an amount of used electric power corresponding to the performance data with an amount of used electric power corresponding to the reference data.

Note that the resource serving as the monitoring subject of the energy-saving diagnostic system 1 is not limited to electric power (electricity), and may be water, gas, or heat. When the resource is water or gas, for example, water pipes and gas pipes for supplying water and gas are disposed in each area of a building such as an office or a store, and valves for opening and closing water and gas flow passages are disposed in the water pipes and gas pipes. By monitoring an open/closed condition of the valves, a use condition (in use/not in use) of the water and gas can be monitored. Further, when the resource is heat, a valve for opening and closing a heating medium flow passage is provided, and by monitoring an open/closed condition of the valve, a use condition (in use/not in use) of the heat can be monitored.

1. An energy-saving diagnostic system that has an evaluation mode and is configured to monitor a use amount of a resource used by a controlled subject, comprising:
a control unit configured to output a control command to adjust the use amount in accordance with predetermined schedule control information;
an information acquisition unit configured to, periodically, obtain information for obtaining the use amount used by said controlled subject as use information;
an information storage unit configured to store time series data in which the use information is associated with at least a date on which the use information is obtained;
a schedule setting unit configured to set the schedule control information;
a comparison and evaluation unit configured to compare the use amounts on either side of a reference point when the evaluation mode is set; and
a display unit,
wherein said comparison and evaluation unit is configured: to set a point in time at which the schedule control information is modified by said schedule setting unit as the reference point; to set the use information obtained over a predetermined period before the reference point as reference data; to set the use information obtained over the aforementioned predetermined period after the reference point as performance data; and to cause said display unit to display an energy saving effect brought about by modifying the schedule control information on the basis of the performance data and the reference data.

2. The energy-saving diagnostic system according to claim 1, wherein
the use amount of the resource is a use time of the resource, thereby said energy-saving diagnostic system is configured to monitor the use time of the resource during respective operations of a plurality of said controlled subjects,
said control unit is configured to control the operations of said plurality of controlled subjects by outputting the control command to said controlled subjects at a predetermined time in accordance with the predetermined schedule control information,
said information acquisition unit is configured to obtain information relating to a use condition of the resource as the use information,
said information storage unit is configured to store the use information in time series in association with the date on which the use information is obtained,
said comparison and evaluation unit is configured to compare the use times of the resource on either side of a start point of the evaluation mode when the evaluation mode is set, or in other words the reference point is the start point of the evaluation mode, and
said comparison and evaluation unit is configured: to compare the performance data to the reference data; and to cause said display unit to display a comparison result, thereby display the energy saving effect brought about by modifying the schedule control information.

3. The energy-saving diagnostic system according to claim 1, wherein said comparison and evaluation unit is configured to generate the reference data from the use information stored in said information storage unit so as to exclude use information obtained on a special day on which the use amount differs from normal.

4. The energy-saving diagnostic system according to claim 3, wherein said information storage unit is configured to store, together with the use information, special day information indicating whether or not a day on which the use information is obtained is the special day.

5. The energy-saving diagnostic system according to claim 1, wherein said comparison and evaluation unit is configured to generate the reference data from the use information stored in said information storage unit so as to exclude use information from which data have been lost.

6. The energy-saving diagnostic system according to claim 1, wherein said comparison and evaluation unit is configured: to calculate a ratio that expresses, as a numerical value, a ratio between the use amount represented by the performance data and the use amount represented by the reference data; and to cause said display unit to display the ratio together with an increase/decrease display indicating whether the use amount has increased or decreased on either side of the reference point.

7. The energy-saving diagnostic system according to claim 6, wherein said comparison and evaluation unit is configured to, when the reference data include the use information obtained on a special day on which the use amount differs from normal or the use information from which data have been lost, cause said display unit to display a warning display, for informing a state of including an abnormal value, within at least one of the ratio and the increase/decrease display.

8. The energy-saving diagnostic system according to claim 6, wherein said comparison and evaluation unit is configured to round up a value of a least significant digit during the calculation of the ratio and to cause said display unit to display a result as the ratio.

9. The energy-saving diagnostic system according to claim 1, wherein said schedule setting unit is configured to automatically start the evaluation mode when the schedule control information is modified in order to reduce the use amount.

10. The energy-saving diagnostic system according to claim 1, wherein said comparison and evaluation unit is configured to set, as the reference data, use information obtained in an identical season to a season in which the performance data are obtained.

11. The energy-saving diagnostic system according to claim 6, wherein said comparison and evaluation unit has a first threshold and a second threshold that is smaller than the first threshold, and is configured to cause said display unit to display different increase/decrease displays according to whether the ratio is larger than the first threshold, within a range of the first threshold and the second threshold, or smaller than the second threshold.

12. The energy-saving diagnostic system according to claim 1, further comprising a setting holding area for storing at least a start day of the evaluation mode.

13. The energy-saving diagnostic system according to claim 12, wherein the setting holding area is configured to also store a duration of the evaluation mode.
